(19) United States
(12) Patent Application Publication
(10) Pub. No.: US 2006/0049597 A1
(43) Pub. Date: Mar. 9, 2006

(54) Vehicle which steering is controllable by its seat

(75) Inventors: Kun-Do Chan, Chang Hua Hsien (TW); Wan-Chu Hung, Chang Hua Hsien (TW)

Correspondence Address: BROWDY AND NEIMARK, P.L.L.C.;624 NINTH STREET, NW, SUITE 300, WASHINGTON, DC, 20001-5303, US

(73) Assignee: J.D. Corporation, Chang Hua Hsien (TW)

(21) Appl. No.: 10/933,529

(22) Filed: Sep. 3, 2004

(51) Int. Cl. B60G 1/00

(52) U.S. Cl. 280/93.504

(57) ABSTRACT

A vehicle includes a chassis, a transmission shaft, a linkage, and a seat. The chassis has two front wheel units pivotally mounted thereto. The transmission shaft is rotatably mounted to the chassis. The linkage is connected between the transmission shaft and the two front wheel units for turning the two front wheel units upon rotation of the transmission shaft. The seat is fixedly mounted on the transmission shaft for the user sitting thereon to turn the transmission shaft and to further turn the two front wheel units relatively to the chassis.

### BACKGROUND OF THE INVENTION

1. Field of the Invention

The present invention relates generally to vehicles, and more particularly to a vehicle that allows the user to control its steering direction by its seat.

2. Description of the Related Art

A conventional vehicle for children is comprised of a chassis, a seat, and a handlebar. The chassis is equipped with two front wheels that can be freely turned to change the steering direction of the vehicle. The seat is mounted at a top side of the chassis. The handlebar is pivoted to the chassis in front of the seat and coupled to the front wheels for driving the front wheels to turn left or right. When sitting on the seat, the user can operate the handlebar with the hands to control the steering direction of the vehicle. However, when the user operates the handlebar to change the steering direction of the vehicle, the user's body may be forced to lean towards the direction opposite to the steering direction of the vehicle, and then the user has to exert much force to the handlebars to hold the body in place, such that this design is inconvenient for steering control.

### SUMMARY OF THE INVENTION

The present invention has been accomplished under the circumstances in view. It is the main object of the present invention to provide a vehicle, which enables the user to control the steering direction by inclining the seat with the body and to have the fun of driving the vehicle.

To achieve the foregoing object of the present invention, the vehicle is comprised of a chassis having two front wheel units pivotally mounted thereto, a transmission shaft rotatably mounted to the chassis, a linkage coupled between the transmission shaft and the two front wheel units for turning the two front wheel units upon rotation of the transmission shaft; and a seat mounted on the transmission shaft for sitting by the user and enabling the user to drive the rotation of the transmission shaft to further turn the two front wheel units relatively to the chassis.

### BRIEF DESCRIPTION OF THE DRAWINGS

FIG. 1 is a perspective view of a first preferred embodiment of the present invention.

FIG. 2 is a top view of the first preferred embodiment of the present invention.

FIG. 3 is a front view of the first preferred embodiment of the present invention.

FIG. 4 is a top view the first preferred embodiment of the present invention at work.

FIG. 5 is another top view the first preferred embodiment of the present invention at work.

FIG. 6 is a front view of a second preferred embodiment of the present invention.

FIG. 7 is a top view of a third preferred embodiment of the present invention.

FIG. 8 is a side view of the third preferred embodiment of the present invention.

### DETAILED DESCRIPTION OF THE INVENTION

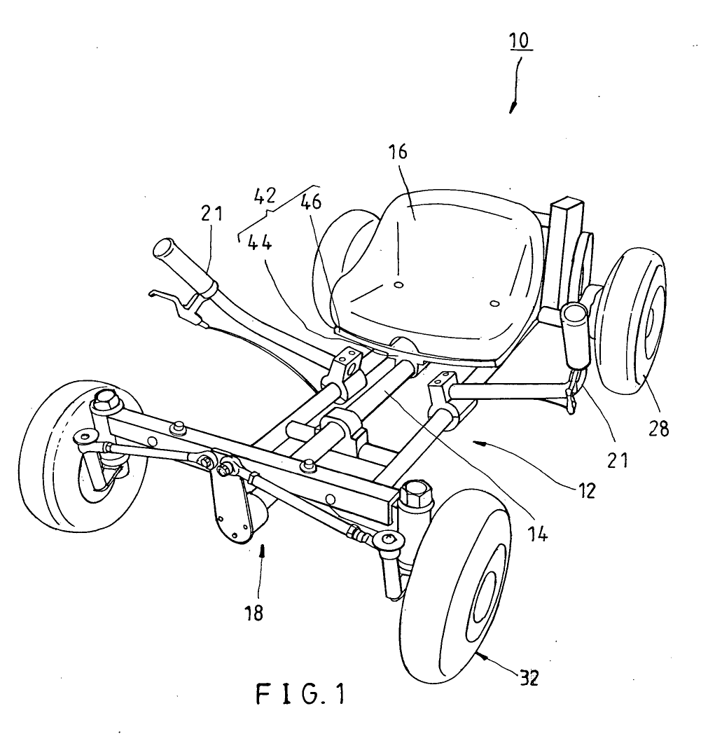

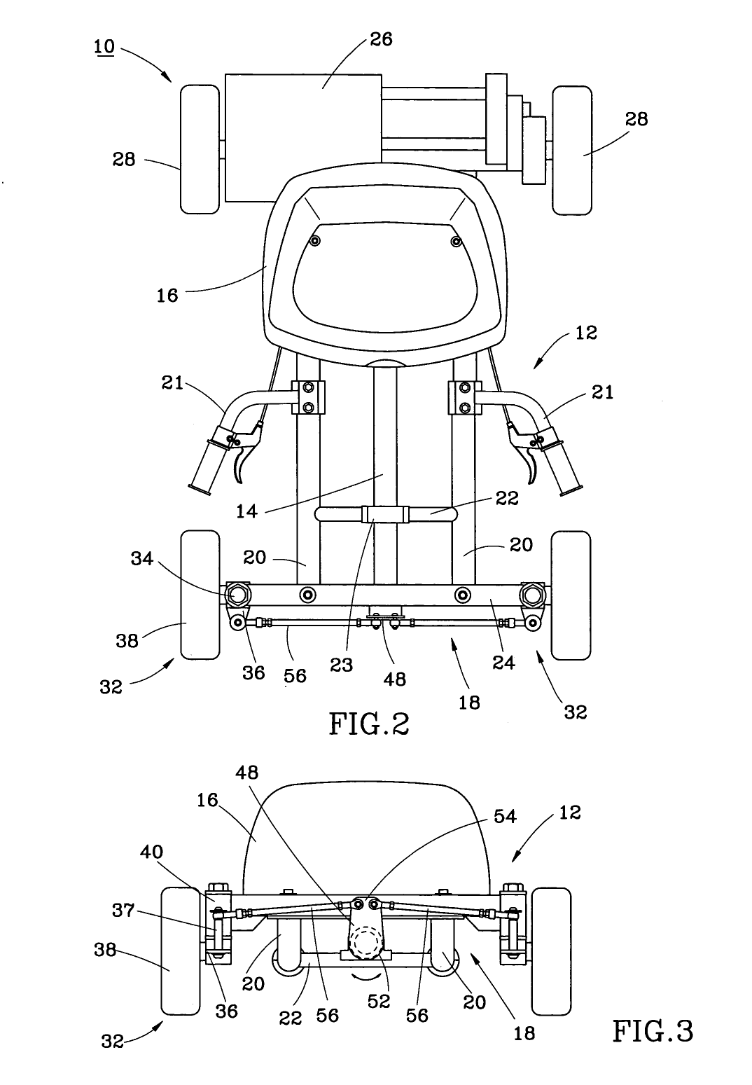

Referring to FIGS. 1-3, a vehicle 10 in accordance with a first preferred embodiment of the present invention is shown comprised of a chassis 12, a transmission shaft 14, a linkage 18, and a seat 16.

The chassis 12 includes two elongated sidebars 20, two crossbars 22 connected between midsections of the sidebars 20, two bearings 23 respectively mounted at midsections of the crossbars 22, a transverse bar 24 fastened to front ends of the sidebars 20, a driving unit 26 fastened to rear ends of the sidebars 20 for turning two rear wheels 28, two control handles 21 mounted respectively to the sidebars 20 for operation by the user to control acceleration and brakeage of the vehicle, two coupling tubes 40 vertically fixedly mounted at two distal ends of the transverse bar 24, and two front wheel units 32 respectively coupled to the coupling tubes 40. Each of the front wheel units 32 includes a wheel axle 34 coupled to each coupling tube 40, a wheel 38 rotatably connected to each of the wheel axles 34, a lug 36 fixedly mounted at a bottom end of each wheel axle 34, and a stem 37 vertically upwardly extending from the lug 36. The wheel axle 34 is coupled to each coupling tube 40 such that each front wheel unit 32 can be turned about the axis of the coupling tube 40 relatively to the chassis 12.

The transmission shaft 14 is a cylindrical shaft running through the bearings 23, passing under a midsection of the transverse bar 24, and located between the sidebars 20. When installed, the transmission shaft 14 can be rotated on the bearings 23 relatively to the chassis 12.

The linkage 18 includes an elongated sheety pivoting member 48 and two links 56. The pivoting member 48 has a first end 52 and a second end 54. The first end 52 of the pivoting member 48 is pivotally connected to the transmission shaft 14 under the transverse bar 24. The second end 54 of the pivoting member 48 is suspended above the chassis 12. Each of the links 56 is coupled between the second end 54 of the pivoting member 48 and a top end of the stem 37 of each front wheel unit 32. Therefore, the links 56 can be moved to drive the two front wheel units 32 to turn left or right relatively to the chassis 12. Further, a shield (not shown) can be mounted over the chassis 12 and the linkage 18 to protect the user from injury that may be incurred by the user's carelessness of touching them and to beautify the appearance of the vehicle 10.

The seat 16 includes a seat frame 42 formed at a bottom side thereof and having a bearing portion 46 and a tubular mounting portion 44 extending downwards from the bearing portion 46. The mounting portion 44 is fixedly fitted to the transmission shaft 14. The bearing portion 46 fixedly supports the seat 16. The seat is fixedly mounted on the transmission shaft 14 via the mounting portion 44, such that when the user sits on the seat 16 and leans leftwards or rightwards, the transmission shaft 14 is rotated clockwise or counterclockwise to drive the linkage 18 to turn the two front wheel units 32.

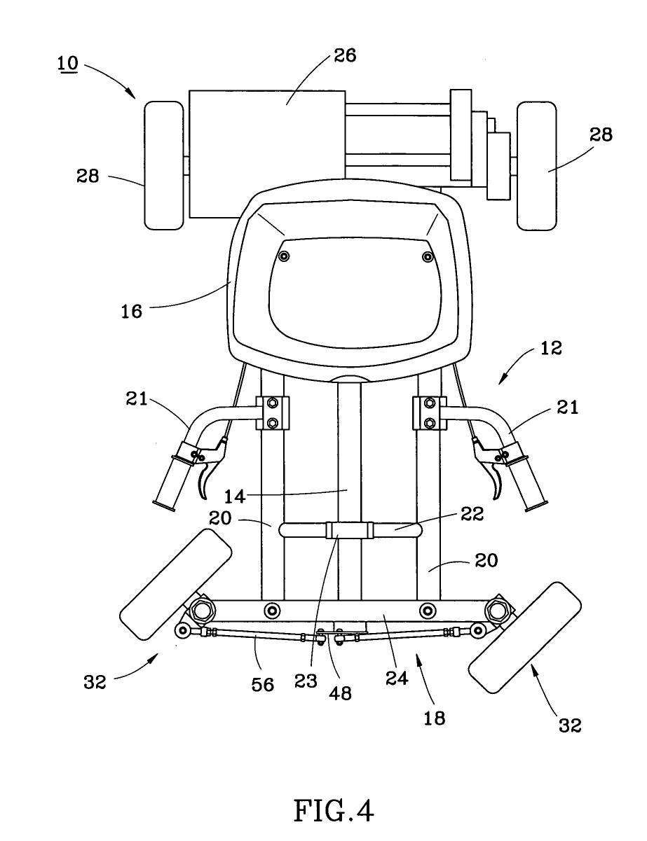

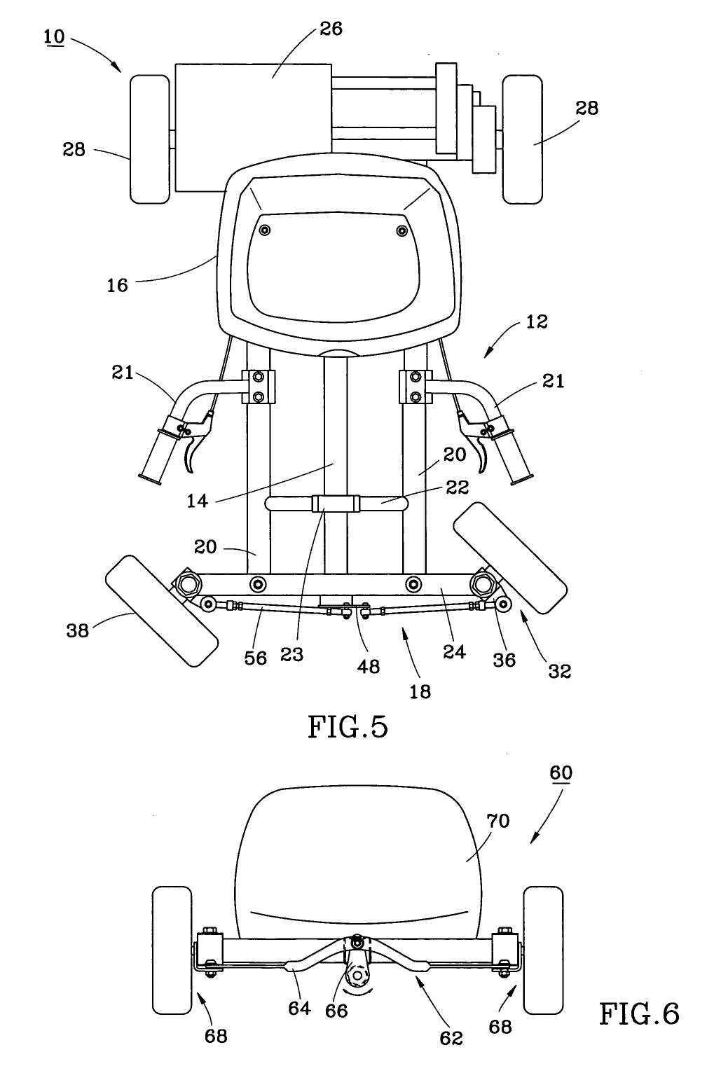

Referring to FIG. 4, when the user intends to control the vehicle to turn right, the user can hold the control handles 21 with the hands and then lean the body rightwards to incline the seat 16 rightwards to drive the links 56 to turn the wheels 38 of the two front wheel units 32 rightwards, such that the chassis 12 is turned right. Referring to FIG. 5, when the user intends to control the vehicle to turn left, the user can hold the control handles 21 with the hands and then lean the body leftwards to incline the seat 16 leftwards to drive the links 56 to turn the wheels 38 of the two front wheel units 32 leftwards, such that the chassis 12 is turned left.

As indicated above, the user can conveniently control the steering direction of the vehicle simply by leaning the body to inline the seat leftwards or rightwards, thereby enjoying the fun of driving the vehicle.

Further, the present invention can also be made to use pedal means to control the driving unit to turn the two rear wheels. The linkage of the vehicle can be made in any of a variety of forms. FIG. 6 shows the vehicle 60 constructed according to a second preferred embodiment of the present invention. This preferred embodiment is substantially similar to the first preferred embodiment, having difference as follows. According to this preferred embodiment, the linkage 62 includes a pivoting member 66 pivotally connected to the transmission shaft (not shown), and a link 64 having a midsection pivoted to an end of the pivoting member 55 spaced from the transmission shaft (not shown) and two distal ends thereof respectively pivotally connected to the two front wheel units 68.

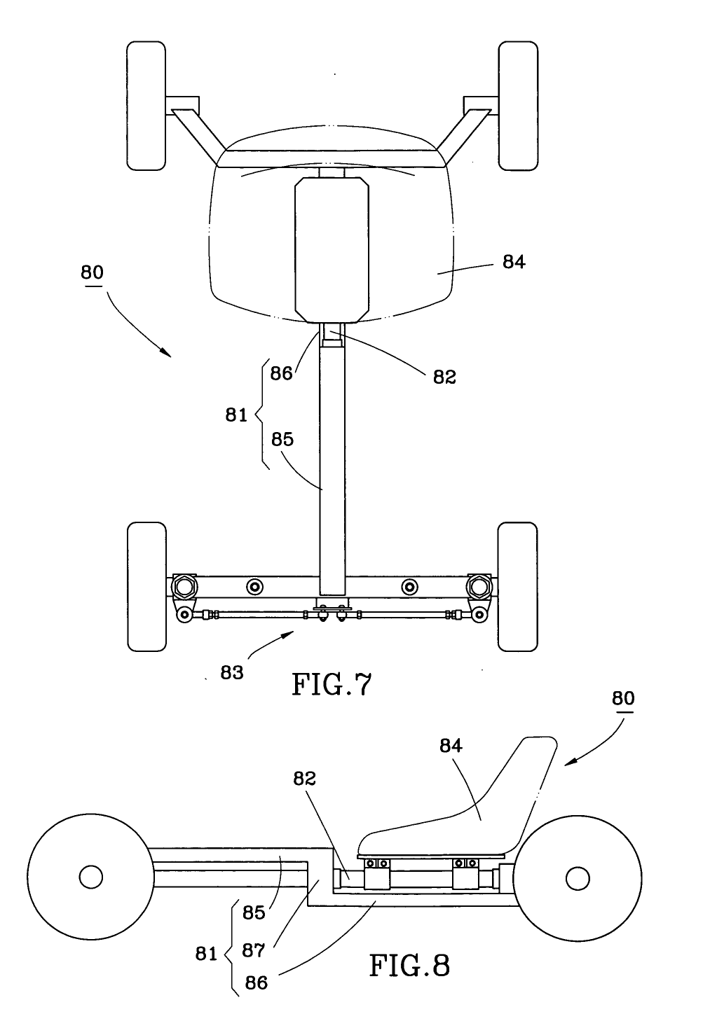

FIGS. 7 and 8 show the vehicle 80 constructed according to a third preferred embodiment of the present invention. Similar to the aforementioned preferred embodiments, the vehicle 80 is comprised of a chassis 81, a transmission shaft 82, a linkage 83, and a seat 84 mounted on the transmission shaft 82. The chassis 81 includes a front bar 85, a rear bar 86, and an upright connecting bar 87. The front bar 85 can be provided with grip means (not shown) for holding by the user's hands. The connecting bar 87 is connected between the front bar 85 and the rear bar 86, being perpendicular to the front bar 85 and the rear bar 86. The transmission shaft 82 is rotatably inserted through the connecting bar 87 and parallel to the front bar 85 and the rear bar 86.

What is claimed is:

1. A vehicle comprising:
a chassis having two front wheel units pivotally mounted thereto;
a transmission shaft rotatably mounted to said chassis;
a linkage connected between said transmission shaft and said two front wheel units for turning said two front wheel units when said transmission shaft is rotated; and
a seat mounted on said transmission shaft for rotating said transmission shaft and further turning said two front wheel units.

2. The vehicle as defined in claim 1, wherein said linkage comprises a pivoting member and two links, said pivoting member being fastened to said transmission shaft, said two links being respectively pivotally connected between said pivoting member and said two front wheel units.

3. The vehicle as defined in claim 2, wherein said two front wheel units each have a lug; said pivoting member has a first end and a second end, said first end of said pivoting member being fixedly connected to said transmission shaft; said two links each have a first end pivoted to the second end of said pivoting member and a second end pivoted to said lug of each of said two front wheel units.

4. The vehicle as defined in claim 1, wherein said linkage further comprises a pivoting member and a link, said pivoting member being fastened to said transmission shaft, said link having two ends pivoted respectively to said two front wheel units.

5. The vehicle as defined in claim 1, wherein said chassis comprises two sidebars, two crossbars vertically connected with said two sidebars, a transverse bar mounted in front of said two sidebars, two control handles respectively mounted on said two sidebars, and two bearings respectively provided at midsections of said two crossbars; said transmission shaft runs through said bearings.

6. The vehicle as defined in claim 1, wherein said seat comprises a seat frame located at a bottom side thereof, said seat frame having a mounting portion and a bearing portion, said mounting portion protruded from said bearing portion and fastened to said transmission shaft.

7. The vehicle as defined in claim 1, wherein said chassis comprises a front bar, a rear bar, and a connecting bar connected between said front bar and said rear bar; said transmission shaft runs through said connecting bar.
